(19) United States
(12) Patent Application Publication
(10) Pub. No.: US 2011/0067587 A1
(43) Pub. Date: Mar. 24, 2011

(54) Multi-functional maintenance friendly pitch-changing apparatus

(75) Inventors: Joseph Adrian ST OURS, Lee, NH (US); Dieter Theodor EBERT, Stratham, NH (US); Mark Anthony WINGATE, New Durham, NH (US)

(73) Assignee: Goss International Americas, Inc., Durham, NH (US)

(21) Appl. No.: 12/924,061

(22) Filed: Sep. 20, 2010

Related U.S. Application Data
(60) Provisional application No. 61/243,727, filed on Sep. 18, 2009.

(51) Int. Cl. B41F 13/24

(52) U.S. Cl. 101/232; 101/485

(57) ABSTRACT

A printing press is provided. The printing press includes a print unit printing a plurality of printed products, the plurality of printed products being formed into a stream downstream of the print unit. The printing press also includes at least one base and a press component, the press component is mounted onto the at least one base for placement in the stream and translational movement transverse to the stream. The press component may be a pitch changing apparatus. A method is also provided.

This claims the benefit of U.S. Provisional Patent Application U.S. 61/243,727, filed Sep. 18, 2009 and hereby incorporated by reference herein.

### BACKGROUND

The present invention relates generally to printing presses and more particularly to conveyors altering the pitch of printed products printed in the printing press.

U.S. Pat. No. 6,176,485, hereby incorporated by reference herein, discloses a diverting device for a continuous sequence of flat products traveling in a product travel plane. A first product exit path and a second product exit path emerge both from said product travel plane.

U.S. Pat. No. 6,405,850 discloses an apparatus for advancing and/or slowing signatures in a printing press. The apparatus and method includes a series of two or more belt drives, where each belt drive includes at least a pair of opposed belts. The belts are preferably timing or toothed belts driven by sprockets.

U.S. Pat. No. 6,561,507 discloses a folder apparatus that includes a conveyor and knock-down wheel assembly to receive signatures from, for example, a tape system output. The conveyor and knock-down wheel assembly slow down the signatures from the tape system and create a shingled output stream of signatures.

U.S. Patent Application Publication 2009/0217833, hereby incorporated by reference herein, discloses an electronic pitch changing apparatus for altering the pitch of printed products. The electronic pitch changing apparatus includes a motor having a variable velocity profile.

### BRIEF SUMMARY OF THE INVENTION

The present invention provides a printing press. The printing press includes a print unit printing a plurality of printed products, the plurality of printed products being formed into a stream downstream of the print unit. The printing press also includes at least one base and a press component, the press component is mounted onto the at least one base for placement in the stream and translational movement transverse to the stream.

The present invention further provides a printing press including a print unit printing a plurality of printed products, the plurality of printed products being formed into a stream downstream of the print unit, the printed product stream having a first pitch. The printing press also includes at least one base and a pitch changing device for changing the first pitch of the stream, the pitch changing device is mounted onto the at least one base for placement in the stream and translational movement transverse to the stream.

The present invention also provides a method. The method includes the step of translating a pitch changing device transverse to a stream to place the device in the stream or to remove the device from the stream.

### BRIEF DESCRIPTION OF THE DRAWINGS

A preferred embodiment of the present invention will be elucidated with reference to the drawings, in which:

FIG. 1 shows a printing press including a printing press component according to the present invention;

FIG. 2 shows an electronic pitch changing apparatus;

FIGS. 3 and 4 show an electronic pitch changing apparatus according to the present invention;

FIGS. 5 to 7 show an electronic pitch changing apparatus in accordance with the present invention for a two story printing press resting in a maintenance position;

FIG. 8 shows the electronic pitch changing apparatus of FIG. 3 being used alternately on two separate printed product streams; and

FIG. 9 shows the electronic pitch changing apparatus of FIG. 3 operating on one of two simultaneous printed product streams.

### DETAILED DESCRIPTION OF PREFERRED EMBODIMENTS

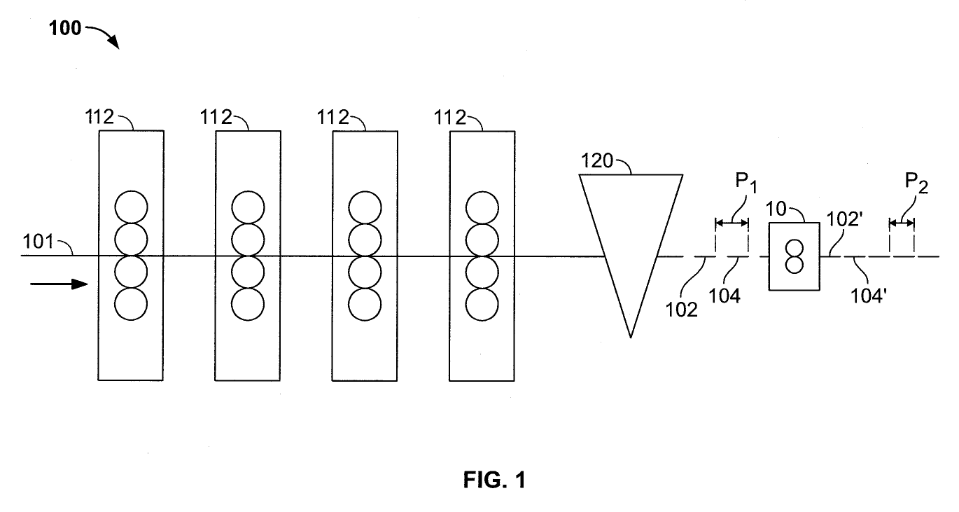

FIG. 1 shows a preferred embodiment of a web printing press 100 in accordance with the present invention including a web 101 traveling through a plurality of printing units 112 and a folder 120 providing a plurality of signatures 102, 104 to a printing press component or module, for example, an electronic pitch changing apparatus 10. Printing units 112, print an image on web 101. Printing units 112 may be web, offset, perfecting printing units. Each print unit 112 may print a different color, for example, cyan, magenta, yellow or black. Folder 120 may include a former board for longitudinally folding a web 101 and/or folder 120 may fold and/or cut web 101 into signatures 102, 104. Signatures have a first pitch, P₁, before entering electronic pitch changing apparatus 10 and a second pitch P₂ after exiting pitch changing apparatus 10.

Electronic pitch changing apparatus 10 alters first pitch P₁ so downstream signatures 102′, 104′ have a second pitch P₂, in this example, P₂ is less than P₁ so signatures 102′, 104′ are closer together than upstream signatures 102, 104. Electronic pitch changing apparatus 10 may also be a slowdown device slowing down the speed of signatures 102′, 104′. Electronic pitch changing apparatus 10 may be similar to the electronic pitch changing apparatus disclosed in U.S. Patent Application Publication 2009/0217833, the entire disclosure of which is hereby incorporated by reference herein.

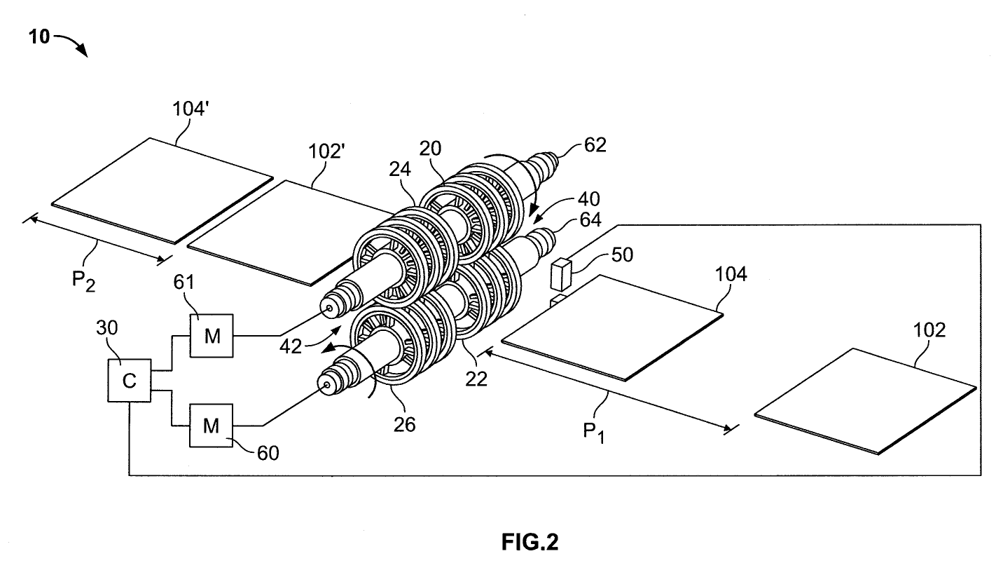

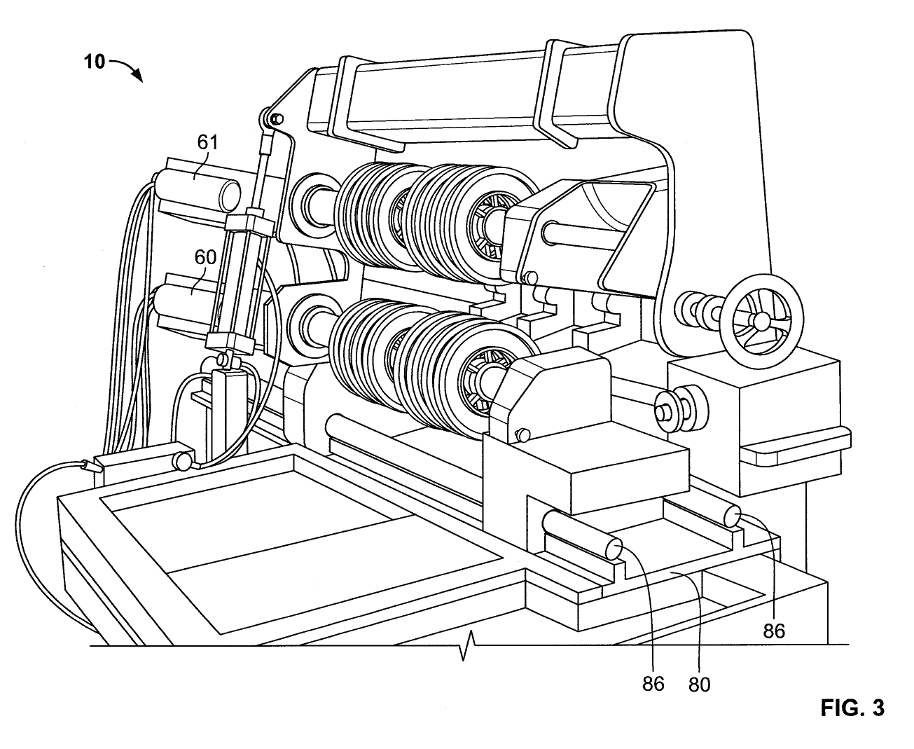

FIG. 2 shows a preferred embodiment of electronic pitch changing apparatus 10. Electronic pitch changing apparatus 10 includes rollers 20, 24 mounted on axle 62 and rollers 22, 26 mounted on axle 64. Roller 20 and roller 22 create a continuous nip 40 and roller 24 and roller 26 create a continuous nip 42. Edge sensors 50 are connected to controller 30 and detect a leading edge of products 104, 102 entering nips 40, 42. Axle 62 rotates in a clockwise direction while axle 64 rotates in a counter-clockwise direction. A motor 60 drives axle 64 directly and a motor 61 drives axle 62 directly. Motors 60, 61 are connected to controller 30.

Electronic pitch changing apparatus 10 works to vary a first pitch P₁ between products 104, 102. Edge sensor 50 will detect the leading edge of products 104, 102 entering nips 40, 42. Controller 30 keeps electronic cam profiles of motors 60, 61 accurately in phase with products 104, 102 to vary initial pitch P₁ to a final pitch P₂ between products 104′ and 102′. Controller 30 automates the initial timing and may reduce interaction and confusion for an operator. The cam profile may be sinusoidal, symmetric or asymmetric. Cam profiles of individual motors do not have to be identical when a diverter or stream separator is used. Electronic pitch changing apparatus 10 advantageously may be used on all folder cutoff lengths since the length of the nips does not need to be resized. Continuous nips advantageously provide flexibility since as little or as much of the nip surface may be used as desired.

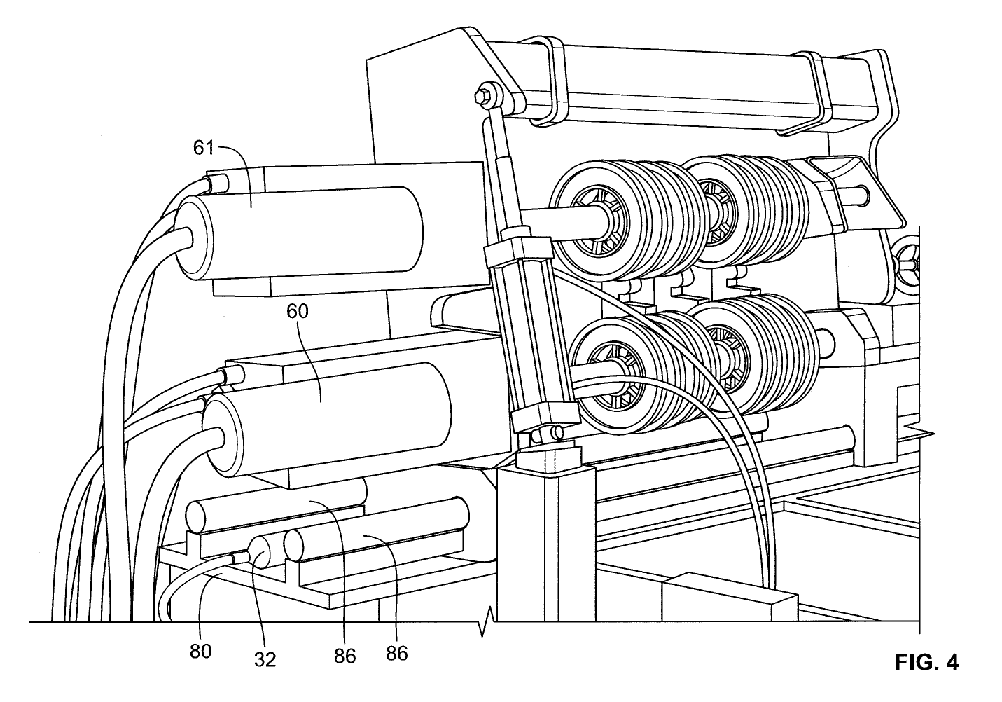

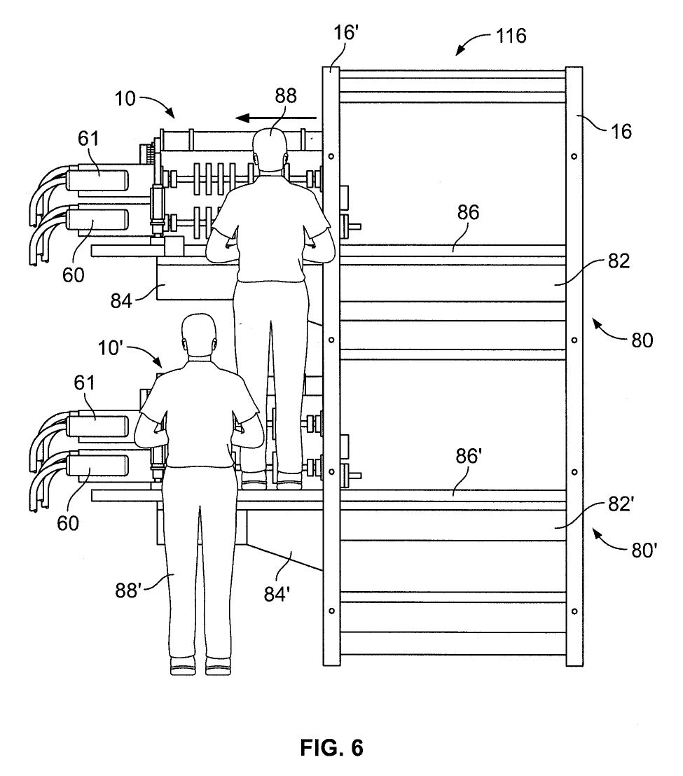

FIGS. 3 and 4 show an electronic pitch changing apparatus 10 mounted on a base 80 in accordance with the present invention. Base 80 includes a pair of slide rails 86. An actuator, for example, pneumatic air cylinder 32 is used to move electronic pitch changing apparatus 10 from a position between frame sidewalls 16, 16′ (FIG. 6) to a maintenance position adjacent sidewall 16′ along slide rails 86 (FIG. 6). Pneumatic flow controls are provided to adjust the speed electronic pitch changing apparatus 10 (or an alternative component or module) moves. A safety device may need to be in place before movement along slide rails 86 is permitted. Manual movement may also be possible. In an alternative embodiment, another type of press component or module, for example, a ribbon stitcher, may be mounted onto base 80 for similar translation movement into and out of the product stream or into and out of a position between frame sidewalls 16, 16′.

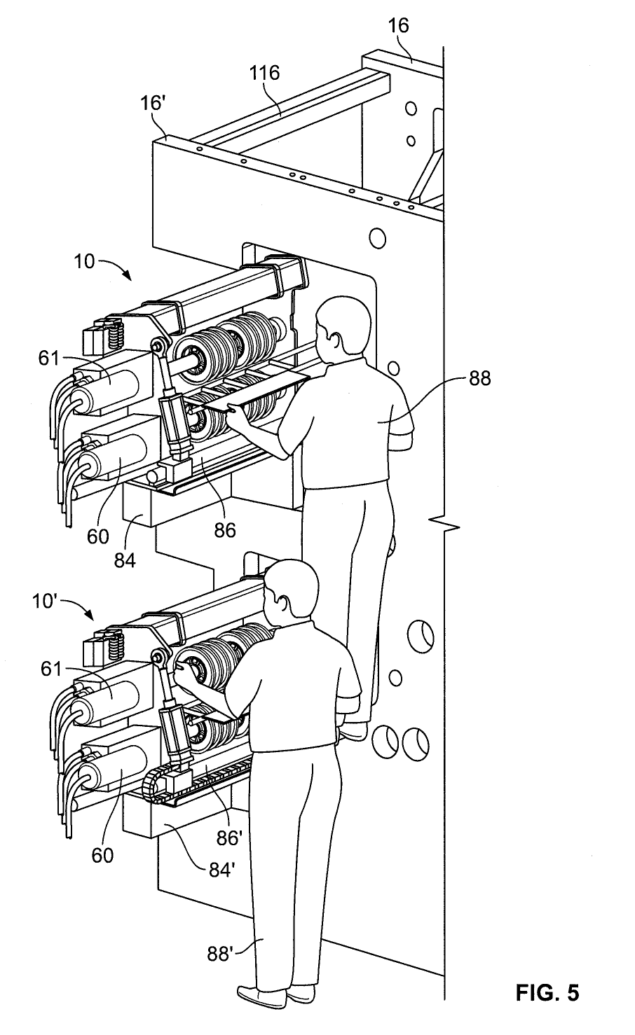

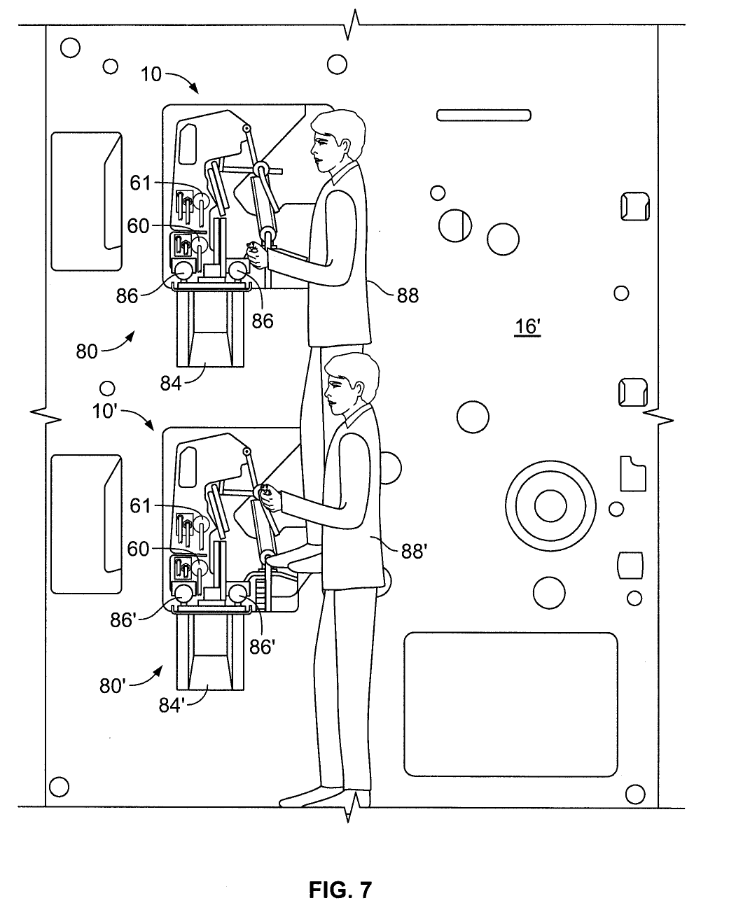

FIGS. 5 to 7 show two electronic pitch changing apparatus 10, 10′, upper and lower, respectively, mounted on bases 80, 80′ in accordance with the present invention for use in a two-story printing press. Electronic pitch changing apparatus 10, 10′ are shown resting in a maintenance position outside of frame 116. Frame may be a folder frame or a printing press frame. Frame 116 includes two sidewalls 16, 16′. Each electronic pitch changing apparatus 10, 10′ is movably mounted on base 80, 80′. In this preferred embodiment, each base 80, 80′ includes an internal base 82, 82′, an external base 84, 84′ and two slide rails 86, 86′. Internal base 82, 82′ may be fixed between frame sidewalls 16, 16′. External base 84, 84′ may be cantilevered to a side of the frame, for example, sidewall 16′. Slide rails 86, 86′ extend from sidewall 16 across internal base 82, 82′ through an opening in sidewall 16′ and continue across to an end of external base 84, 84′. In an alternative embodiment internal base 82 and external base 84 may be designed as a single base component. In another alternative embodiment, base 80 may be designed to fully cantilever electronic pitch changing apparatus in between frame sidewalls 16, 16′. In further embodiment, base 80 may have a fixed portion and a movable portion.

Electronic pitch changing apparatus 10, 10′ are able to slide along slide rails 86, 86′ into a press operating position between frame sidewalls 16, 16′ to a maintenance position outside of frame 116 adjacent sidewall 16′ (shown) via pneumatic air cylinder 32 (FIG. 4). In the maintenance position, operators 88, 88′ may easily access electronic pitch changing apparatus 10, 10′ for repairs, replacement or substitution.

In addition, when either or both electronic pitch changing apparatus 10, 10′ are in need of repair or malfunction, the electronic pitch changing apparatus 10, 10′ may be removed from base 80, 80′ by moving electronic pitch changing apparatus 10, 10′ from the press operating position to the maintenance position and subsequently removing electronic pitch changing apparatus 10, 10′ from slide rails 86, 86′. A replacement electronic pitch changing apparatus may be mounted to slide rails 86, 86′ and slid into the press operating position between frame sidewalls 16, 16′ so the press may continue to run, thereby reducing press downtime during a malfunction.

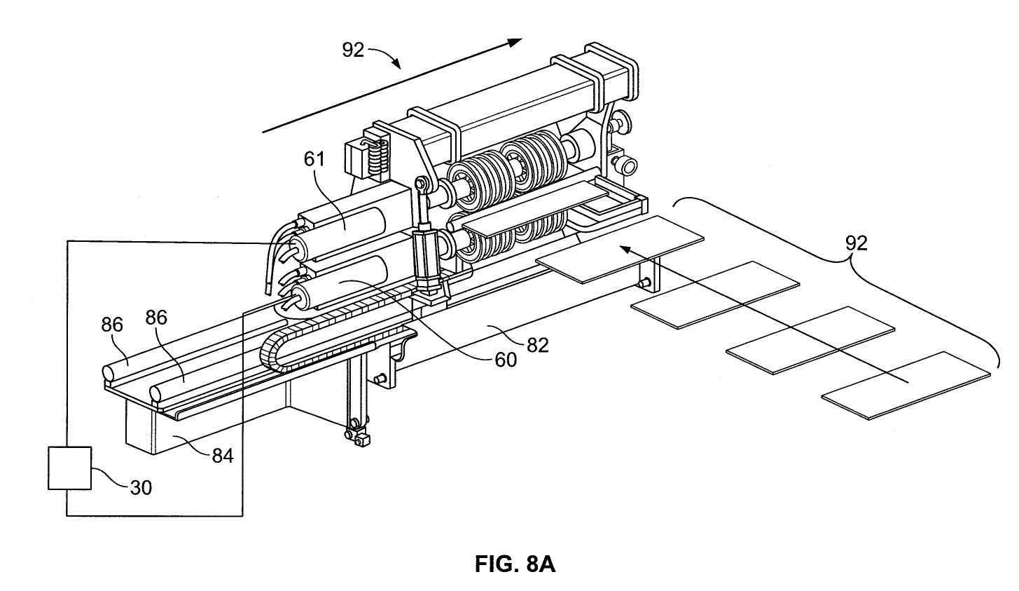

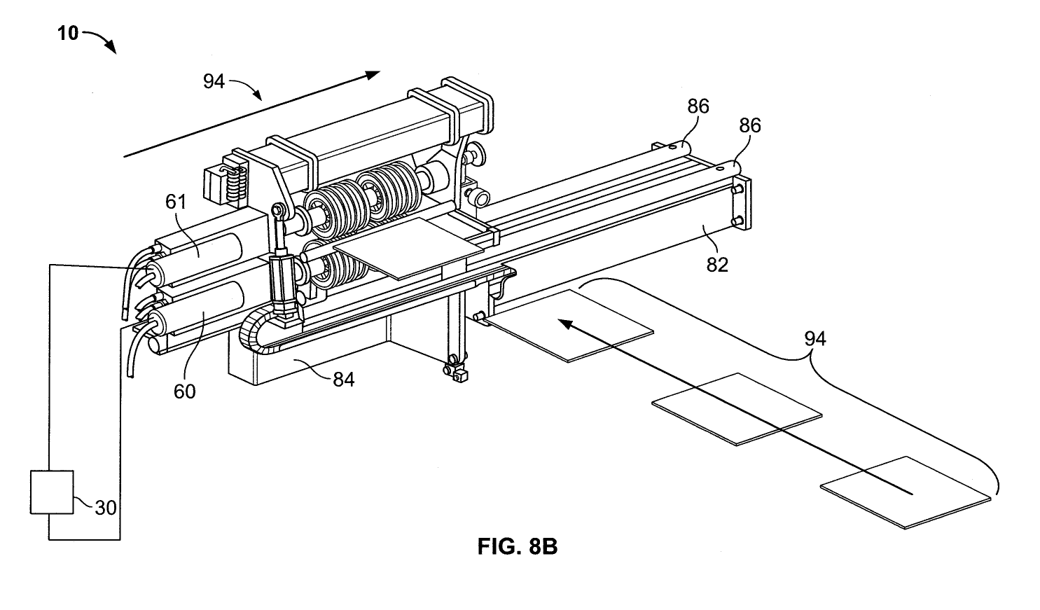

FIG. 8 shows another preferred embodiment of electronic pitch changing apparatus 10 being used alternately on two separate printed product streams. In FIG. 8, internal base 82 extends across a length transverse to a long grain product stream 94 and a short grain product stream 92. Thus, electronic pitch changing apparatus 10 may operate on a stream 94 or be moved into a second operating position and operate on stream 92. Electronic pitch changing apparatus 10 may be easily and quickly moved into stream 92 or into stream 94 by sliding electronic pitch changing apparatus over slide rails 86 of base 80. Electronic velocity profiles of motors 60, 61 may be quickly changing software via controller 30. Thus, electronic pitch changing apparatus 10 may be easily integrated into two different product streams having products with different cutoffs.

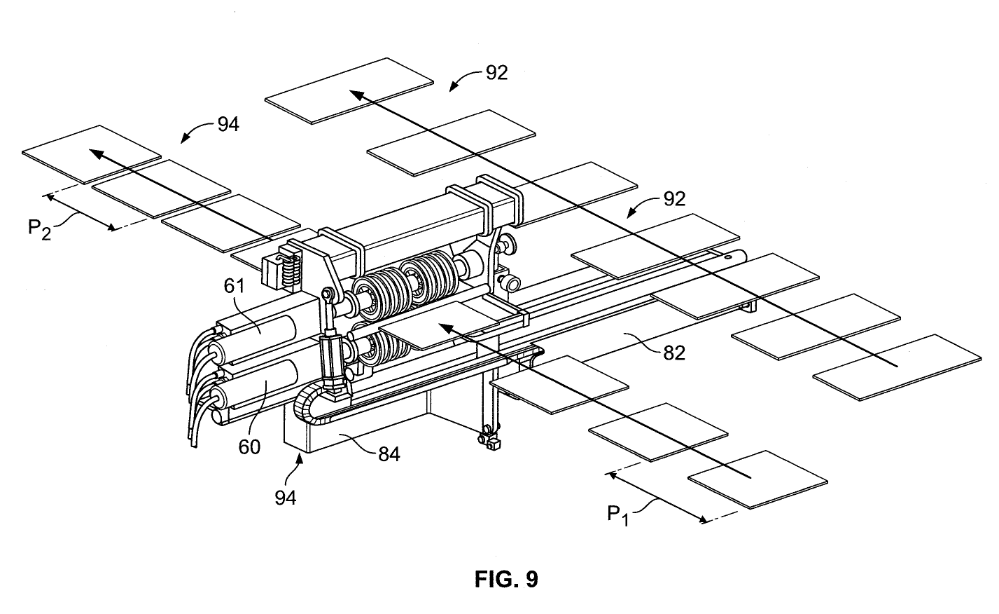

FIG. 9 shows another preferred embodiment of electronic pitch changing apparatus 10 operating on one of two simultaneous printed product streams. In FIG. 9, internal base 82 extends across a length transverse to a long grain product stream 94 and a short grain product stream 92. Electronic pitch changing apparatus 10 is setup to reduce the first pitch P₁ of products in long grain product stream 94 to a smaller pitch P₂ while products in short grain product stream 92 are unaltered by electronic pitch changing apparatus 10. Products in product stream 92 are conveyed over internal base 82 further downstream.

Electronic pitch changing apparatus 10 mounted on base 80 provides many advantages. For example, an advantage may include the ability to move electronic pitch changing apparatus 10 from an existing press 100 (FIG. 1) to an alternative press. Since electronic pitch changing apparatus 10 works on a variety of cutoffs, electronic pitch changing apparatus 10 can be placed in an alternative press running the same cutoff or running a different cutoff. A change in software controlling the velocity profile for motors 60, 61 may also be required.

Another advantage may include the ability to easily replace a broken or malfunctioning electronic pitch changing apparatus 10 with a replacement electronic pitch'changing apparatus in order to reduce press downtime and continue printing with minimum disruption.

Furthermore, as desired, an alternative printing press component or module may be used to replace electronic pitch changing apparatus 10, for example, a ribbon stitcher. When this occurs, a drive system including motors 60, 61 may be left in place. Electronic pitch changing apparatus 10 may be disconnected from motors 60, 61 and a ribbon stitcher may be connected to motors 60, 61 so ribbon stitcher may be easily integrated into the existing printing press setup. A velocity profile for the motors may be modified as necessary.

The present invention advantageously eliminates the use of tapes in a pitch changing apparatus and advantageously improves accessibility of the pitch changing apparatus for maintenance thereby reducing machine downtime during repair, malfunction or routine maintenance.

The present invention advantageously satisfies the need for a pitch changing device that can work on multiple cutoffs and multiple product streams with ease and with a cost savings.

The present invention advantageously provides a pitch changing device that can be used in any printing press regardless of product cutoff and advantageously increases the ease of assembling, maintaining and adjusting the pitch changing device. Sensitivity to jamming may also be reduced.

By translating the pitch changing device outside of the machine for maintenance and adjustments the operator has easy access to the entire assembly. This allows the operator to make quick adjustments with minimal effort and impedance form other parts of the machine. The present invention also makes replacement of the entire assembly easily achievable by simply sliding the exciting device completely off the guide rails and replacing it with a new or rebuilt one. Since there are no tapes running through the device, collateral damage to the device from tape failure is also significantly reduced. An added feature of this invention is its dual usage capability. In a folder that has side by side fold cylinders of different cutoffs or grain orientations (short grain v. long grain) this device could be shared by both product streams. By sliding the device into the appropriate product stream for the current job and changing the drive profile controlling the nip rolls it is possible to run multiple product formats through the shared device. It is also possible to run both streams simultaneously with the device only acting on one stream, while product flows through the second stream unaltered by the device.

The present invention may also be removed from one machine and placed into a different machine to either do a similar function with the same cutoff or be used for a different function or different cutoff by changing software to adjust the motors. In some cases the mechanical drive module could be reused with different press components or modules, such as replacing the pitch changing mechanism with a ribbon stitching mechanism and different control software. Ribbon stitchers are typically cutoff specific by design, whereas this invention would allow use of a common stitcher on different cutoff machines, or variable cutoff machines.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press comprising:
a print unit printing a plurality of printed products, the plurality of printed products being formed into a stream downstream of the print unit;
at least one base; and
a press component, the press component mounted onto the at least one base for placement in the stream and translational movement transverse to the stream.

2. A printing press comprising:
a print unit printing a plurality of printed products, the plurality of printed products being formed into a stream downstream of the print unit, the printed product stream having a first pitch;
at least one base; and
a pitch changing device for changing the first pitch of the stream, the pitch changing device mounted onto the at least one base for placement in the stream and translational movement transverse to the stream.

3. The printing press as recited in claim 2 further comprising a further stream of printed products, the pitch changing device mounted on the at least one base for placement into the further stream and translational movement transverse to the further stream.

4. The printing press as recited in claim 2 wherein the pitch changing device may be removed from the at least one base.

5. The printing press as recited in claim 2 wherein the pitch changing device is movably mounted to the at least one base.

6. The printing press as recited in claim 2 wherein the at least one base includes an internal base, an external base and slide rails.

7. The printing press as recited in claim 2 further comprising a frame surrounding a portion of the at least one base or stream so as to define an operating position and a maintenance position.

8. The printing press as recited in claim 2 further comprising a further pitch changing device which may be mounted onto the at least one base after the pitch changing device is removed from the at least one base.

9. The printing press as recited in claim 2 further comprising an actuator to slide the pitch changing device along the at least one base.

10. The printing press as recited in claim 2 further comprising a pneumatic air cylinder to slide the pitch changing device along the at least one base.

11. The printing press as recited in claim 2 wherein the stream is located between two sidewalls and the pitch changing device is moved from a position adjacent one sidewall into a position between the two sidewalls.

12. The printing press as recited in claim 11 wherein the at least a portion of the at least one base extends into the stream between the two sidewalls.

13. The printing press as recited in claim 12 wherein the at least a portion of the base is a slide rail.

14. The printing press as recited in claim 2 wherein the pitch changing devices moves with respect to the base.

15. The printing press as recited in claim 2 further comprising a controller.

16. The printing press as recited in claim 2 wherein the pitch changing device further includes a plurality of motors and a controller.

17. The printing press as recited in claim 3 wherein the further product stream includes products have a different cutoff than printed products in the stream.

18. A method comprising the steps of:
translating a pitch changing device transverse to a stream to place the device in the stream or to remove the device from the stream.

19. The method recited in claim 18 wherein the step of translating includes moving the pitch changing device along a slide rail.
